(19) United States
(12) Patent Application Publication
(10) Pub. No.: US 2025/0276565 A1
(43) Pub. Date: Sep. 4, 2025

(54) ELECTRONIC SKY SCREEN AND MOUNTING STRUCTURE THEREOF

(71) Applicant: SHINING VICTORY INTERNATIONAL HOLDINGS CO., LIMITED TAIWAN BRANCH, Tainan City (TW)

(72) Inventor: Keng-Sheng CHEN, New Taipei City (TW)

(73) Assignee: SHINING VICTORY INTERNATIONAL HOLDINGS CO., LIMITED TAIWAN BRANCH, Tainan City (TW)

(21) Appl. No.: 18/593,552

(22) Filed: Mar. 1, 2024

(51) Int. Cl. B60J 3/04; G02F 1/01

(52) U.S. Cl. CPC B60J 3/04; G02F 1/0102

(57) ABSTRACT

An electronic sky screen and a mounting structure are provided. The electronic sky screen includes a frame assembly, a film element, a separating connector and a fixed connector. The film element is arranged in the frame assembly, and the separating connector is inserted into the gap between the ceiling and the sunroof glass to connect with the frame assembly. The fixed connector is provided on the frame assembly for connecting to the gap between the ceiling and the sunroof glass. The electronic sky screen is hung on the sunroof glass by the separating connector and the fixed connector, so as to achieve non-destructive installation, high installation efficiency, good effect, convenient maintenance, reducing installation difficulty, and the installation can be easily executed by the customers.

### BACKGROUND OF THE INVENTION

### 1. Field of the Invention

The present invention relates generally to a field of automobile accessories, and more particularly, to an electronic sky screen and mounting structure thereof.

### 2. The Prior Arts

The electronic sky screen is an accessory installed on the car sunroof, which can adjust the light transmittance of a film through a controller to adapt to outdoor lighting conditions. The existing electronic sky screen is usually directly bonded to the sunroof glass, which is difficult, time-consuming, and labor-intensive to and can be easily damaged during the installation.

### SUMMARY OF THE INVENTION

In order to address the shortcomings of the existing technology, the present invention provides a technical solution for an electronic sky screen and mounting structure thereof.

The present invention provides an electronic sky screen, comprising: a frame assembly; a film element, disposed in the frame assembly; at least a separating connector, disposed in a gap between a ceiling and a sunroof glass for connecting to the frame assembly; and, at least a fixed connector, disposed on the frame assembly and used to connect with the gap between the ceiling and the sunroof glass; wherein the electronic sky screen being mounted to the sunroof glass by the separating connector and the fixed connector.

In a preferred embodiment, the frame assembly comprises a decorative frame and a mounting frame, the decorative frame corresponds to the interior of a car, and the mounting frame is provided on the back of the decorative frame and corresponds to the exterior of the car.

In a preferred embodiment, the decorative frame and the mounting frame are bonded or connected through fasteners or snap-fitted.

In a preferred embodiment, the mounting frame includes four frame bars connected end to end, and adjacent frame bars are connected through right-angle connectors.

In a preferred embodiment, a fixed base is provided on the frame assembly, and the fixed base is used to connect with the separating connector.

In a preferred embodiment, the separating connector includes a horizontal separating connection part and a vertical separating connection part; the horizontal separating connection part is inserted into the gap between the ceiling and the sunroof glass, and the vertical separating connection part is used to connect to frame assembly.

In a preferred embodiment, the fixed connector includes a horizontal fixed connection part and a vertical fixed connection part; the horizontal fixed connection part is to be inserted into the gap between the ceiling and the sunroof glass, and the vertical fixed connection part is connected to the frame assembly.

In a preferred embodiment, the fixed connector and the separating connector are respectively connected to two opposite sides of the frame assembly.

In a preferred embodiment, the film element includes an adhered color-changing film and a base material layer; the color-changing film is connected to a controller through a wire harness.

The present invention also provides a mounting structure, comprising: a ceiling and an electronic sky screen as described above, a sunroof glass being provided on the ceiling, and the separating connectors and fixed connectors of the electronic sky screen are inserted into the gap between surrounding edges of the sunroof glass and the ceiling so as to hang the electronic sky screen on the sunroof glass.

Compared with the existing technology, the beneficial effects of the present invention are: the overall structure of the electronic sky screen of the present invention is to be mounted on the surface of the original car ceiling, achieving non-destructive installation, high installation efficiency, good effect, convenient maintenance, and reducing installation difficulty so that customers are able to perform the mounting.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is an exploded schematic view illustrating the first embodiment of the present invention;

FIG. 2 is a schematic view illustrating the exterior structure of the second embodiment of the present invention; and

FIG. 3 is a schematic view illustrating the interior structure of the second embodiment of the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

In the description of the present invention, it should be understood that the terms, such as, “one end”, “other end”, “outside”, “upper”, “inside”, “level”, “coaxial”, “center”, “end”, “length”, “outer end”, etc. are based on the orientation or positional relationship shown in the drawings. They are only for the convenience of describing the present invention and simplifying the description, and do not indicate or imply that the devices or components must have a specific orientation, be constructed and operate in a specific orientation and therefore are not to be construed as limitations of the invention.

### Embodiment 1

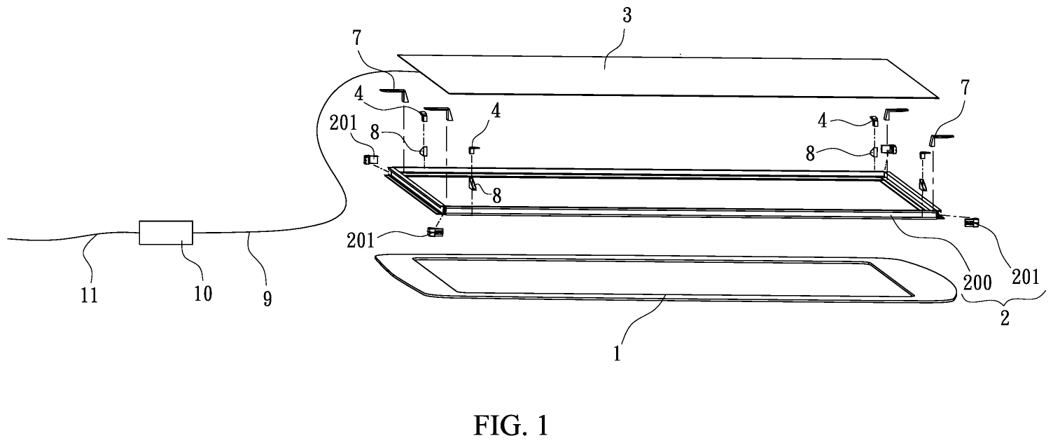

FIG. 1 shows an electronic sky screen, including a frame assembly, a film element 3, a plurality of separating connectors 4 and a plurality of fixed connectors 7. The film element 3 is arranged in the frame assembly. The plurality of separating connectors 4 are arranged in the gap between the ceiling 5 and the sunroof glass 6, and are used to connect with the frame assembly. The plurality of fixed connectors 7 are arranged on the frame assembly, and are used to connect with the gap between the ceiling 5 and the sunroof glass 6. The electronic sky screen of the present embodiment is hung on the sunroof glass 6 through the separating connectors 4 and the fixed connectors 7.

Wherein, the separating connector 4 and the fixed connector 7 are manufactured as injection molded parts, and are located on opposite sides of the present embodiment. The separating connector 4 and the fixed connector 7 can also be added on the other two sides as needed.

It can be understood that in the above technical solution, the present embodiment is connected to the sunroof glass 6 through the separating connectors 4 and the fixed connectors 7. In order to avoid the problem of parts interference affecting the installation, the separating connectors 4 in the present embodiment are separated from the frame assembly, and are hung in advance between the gap between the sunroof glass 6 and the ceiling 5. The fixed connectors 7 are pre-fixed on the frame assembly, and then the fixed connectors 7 are hung on other side between the gap of the sunroof glass 6 and the ceiling 5, and finally, the frame assembly is connected to the separating connector 4 to realize the installation of the present embodiment. The entire operation process is simple and labor-saving, and the customers can perform by themselves after receiving the present invention.

Moreover, the frame assembly includes a decorative frame 1 and a mounting frame 2. The decorative frame 1 corresponds to the interior side of the car. The mounting frame 2 is set on the back of the decorative frame 1 and corresponds to the exterior side of the car. The decorative frame 1 and the mounting frame 2 can be fixed by bonding, fastener connection, clamping, snap-fitting, etc.

Wherein, the film element 3 is installed in the middle of the mounting frame 2 by bonding, snapping or crimping. The decorative frame 1 is formed by injection molding or simple molding. The area of the decorative frame 1 is larger than the mounting frame 2, and can cover the mounting frame to serve a decorative purpose.

Referring further to FIG. 1, the mounting frame 2 is a rectangular frame, which includes four frame bars 200 connected end to end. The frame bars 200 have a U-shaped grooved tube structure, and corner connectors 201 are provided between adjacent frame bars 200. The corner connectors 201 are preferably right-angle connectors, which are connected to the frame bars 200 by bonding, snapping or fastener connection, thereby assembled to form a complete mounting frame 2.

Also referring to FIG. 1, in the present embodiment, a fixed base 8 is provided on the mounting frame 2 through bonding, snapping, or fastener connection. The fixed base 8 is connected to the separating connectors through bonding, snapping, or fastener connection in one-to-one correspondence, and the fixed base 8 is made of injection molded parts.

In another embodiment, the structure of the fixed base 8 can be eliminated, so that the separating connector 4 is directly connected to the mounting frame 2 by bonding, snapping, or fastener connection during assembly.

As shown in FIG. 1, the structure of the separating connector 4 is approximately L-shaped, including a horizontal separating connection part and a vertical separating connection part. The horizontal separating connection part is inserted into the gap between the ceiling 5 and the sunroof glass 6. The vertical separating connection part is used to connect with the mounting frame 2. The structure of the fixed connector 7 is also similar to an L shape, including a horizontal fixed connection part and a vertical fixed connection part. The horizontal fixed connection part is inserted into the gap between the ceiling 5 and the sunroof glass 6. The vertical fixed connection part is connected to the mounting frame 2.

In the present embodiment, the film element 3 is a widely-known technology, including a bonded color-changing film and a base material layer. The color-changing film can be PDLC/EC/SPC/EPC color-changing film, and the base material layer can be transparent film sheet, such as, PC, PMMA, ABS, etc. The color-changing film is connected to the controller 10 through a wire harness 9, and the controller 10 is connected to the power supply through a power cord 11. The frame assembly has a gap corresponding to the wire harness 9 so that the wire harness 9 can extend through.

### Embodiment 2

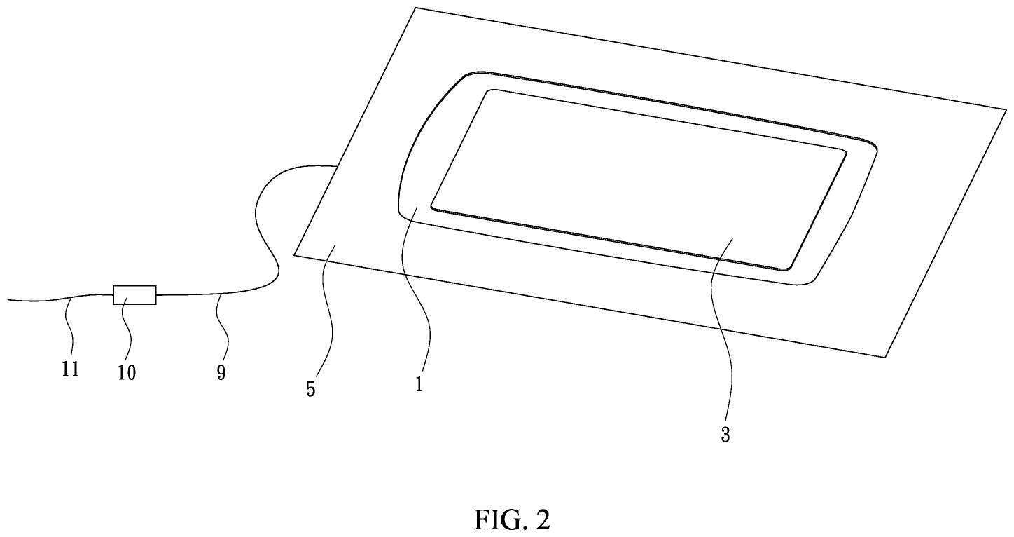

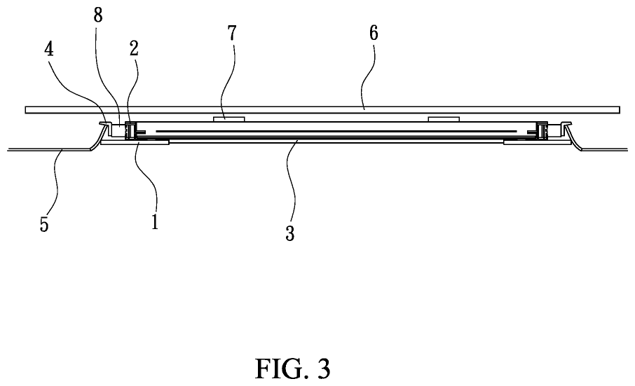

Refer to FIGS. 2 and 3, which shows a mounting structure including a ceiling 5 and an electronic sky screen as described in Embodiment 1. A sunroof glass 6 is provided on the ceiling 5, and both the separating connectors 4 and the fixed connectors 7 of the electronic sky screen are inserted into the gap between the surrounding circumference of the sunroof glass 6 and the ceiling 5. As such, the electronic sky screen is mounted on the sunroof glass 6.

The installation process of the present embodiment includes: the decorative frame 1, the mounting frame 2, the fixed base 8, and the fixed connector 7 are assembled together in advance before shipping from the factory. After the customer receives the product, the first step is to hook the fixed connector 7 to the gap between the ceiling 5 and the sunroof glass 6, and the second step is to hang the separating connector 4 into the gap between the ceiling 5 and the sunroof glass 6, located on the opposite side of the fixed connector 7, and finally the last step is to connect the separating connector 4 to the fixed base 8 on the mounting frame 2 to complete the installation of the electronic sky screen.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An electronic sky screen, comprising:
a frame assembly;
a film element, disposed in the frame assembly;
at least a separating connector, disposed in a gap between a ceiling and a sunroof glass for connecting to the frame assembly; and
at least a fixed connector, disposed on the frame assembly and used to connect with the gap between the ceiling and the sunroof glass; wherein the electronic sky screen being mounted to the sunroof glass by the separating connector and the fixed connector.

2. The electronic sky screen according to claim 1, wherein the frame assembly comprises a decorative frame and a mounting frame, the decorative frame corresponds to the interior of a car, and the mounting frame is provided on the back of the decorative frame and corresponds to the exterior of the car.

3. The electronic sky screen according to claim 2, wherein the decorative frame and the mounting frame are bonded or connected through fasteners or snap-fitted.

4. The electronic sky screen according to claim 2, wherein the mounting frame includes four frame bars connected end to end, and adjacent frame bars are connected through right-angle connectors.

5. The electronic sky screen according to claim 1, wherein a fixed base is provided on the frame assembly, and the fixed base is used to connect with the separating connector.

6. The electronic sky screen according to claim 1, wherein the separating connector includes a horizontal separating connection part and a vertical separating connection part; the horizontal separating connection part is inserted into the gap between the ceiling and the sunroof glass, and the vertical separating connection part is used to connect to frame assembly.

7. The electronic sky screen according to claim 1, wherein the fixed connector includes a horizontal fixed connection part and a vertical fixed connection part; the horizontal fixed connection part is to be inserted into the gap between the ceiling and the sunroof glass, and the vertical fixed connection part is connected to the frame assembly.

8. The electronic sky screen according to claim 1, wherein the fixed connector and the separating connector are respectively connected to two opposite sides of the frame assembly.

9. The electronic sky screen according to claim 1, wherein the film element includes an adhered color-changing film and a base material layer; the color-changing film is connected to a controller through a wire harness.

10. A mounting structure, comprising: a ceiling and an electronic sky screen as described above, a sunroof glass being provided on the ceiling, and the separating connectors and fixed connectors of the electronic sky screen are inserted into the gap between surrounding edges of the sunroof glass and the ceiling so as to hang the electronic sky screen on the sunroof glass.
